(19) United States
(12) Patent Application Publication
(10) Pub. No.: US 2013/0241517 A1
(43) Pub. Date: Sep. 19, 2013

(54) POWER CIRCUIT HAVING THREE-TERMINAL REGULATOR

(71) Applicant: YONG-SONG SHI, Shenzhen City (CN)

(72) Inventor: YONG-SONG SHI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/437,021

(22) Filed: Apr. 2, 2012

(30) Foreign Application Priority Data
Mar. 16, 2012 (CN) 201210069302.5

(51) Int. Cl. G05F 3/04

(52) U.S. Cl. 323/304

(57) ABSTRACT

A power circuit includes a power input port, a power output port, and a three-terminal regulator. A voltage regulating circuit and a charge/discharge circuit are connected to the power output port. The three-terminal regulator detects a voltage value of the output port and enables the input port if the detected voltage value is less than a predetermined voltage value and disables the input port if the detected voltage value is not less than the predetermined value. If the input port of the three-terminal regulator is enabled, the charge/discharge circuit is charged by the current provided by a power supply connected to the power input port. If the input port of the three-terminal regulator is disabled, the charge/discharge circuit discharges to an electronic device connected to the power output port with the voltage regulating circuit.

### BACKGROUND

1. Technical Field

The present disclosure relates to power circuits and, particularly, to a power circuit having a three-terminal regulator capable of increasing power output efficiency.

2. Description of the Related Art

A power circuit employed in an electronic device may include a three-terminal regulator for converting a higher voltage to a lower voltage, which results in a low efficiency and a high heat loss or consumption. Referring to FIG. 1, a power circuit 10 of related art includes an integrated three-terminal regulator 11. The integrated three-terminal regulator 11 includes an input port 110, a first output port 111, and a second output port 112. The input port 110 is connected to a power supply (not shown). The first output port 111 and the second output port 112 are connected to a power output port 12 of the power circuit 10. The integrated three-terminal regulator 11 converts the voltage provided by the power supply into a predetermined voltage and outputs the converted voltage. For example, if the voltage provided by the power supply is 12V, and the predetermined voltage is 3.3V, a power supply transition efficiency of the circuit 10 is P=Vout/Vin=3.3V/12V=27.5%, and power lost as heat in the circuit 10 is Pd=(Vin−Vout)*Iout=(12V−3.3V)*I.

### BRIEF DESCRIPTION OF THE DRAWINGS

The components in the drawings are not necessarily drawn to scale, the emphasis instead being placed upon clearly illustrating the principles of the disclosure. Moreover, in the drawing, like reference numerals designate corresponding parts throughout the several views.

FIG. 1 is a circuit diagram of a power circuit of related art having a three-terminal regulator.

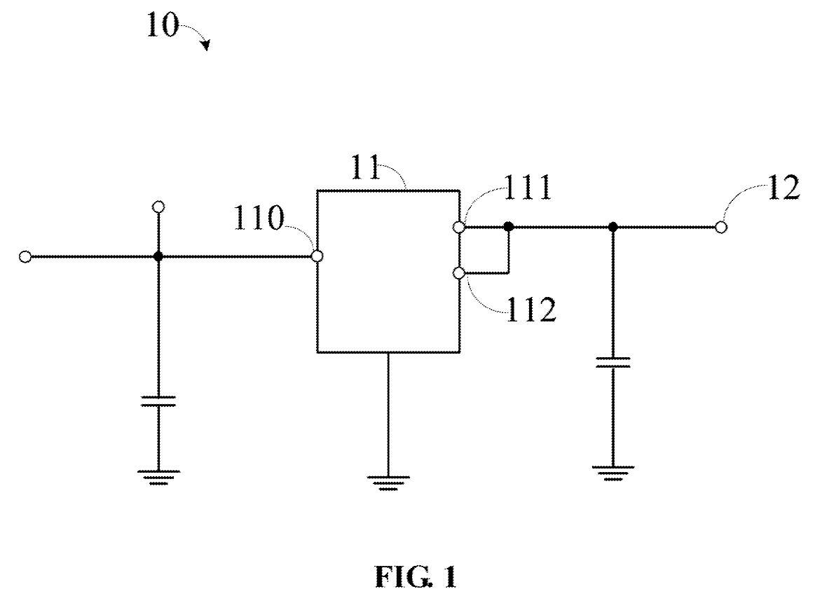

FIG. 2 is a block diagram of a power circuit having a three-terminal regulator in accordance with an exemplary embodiment.

FIG. 3 is a circuit diagram of the power circuit of FIG. 2 in accordance with an exemplary embodiment.

### DETAILED DESCRIPTION

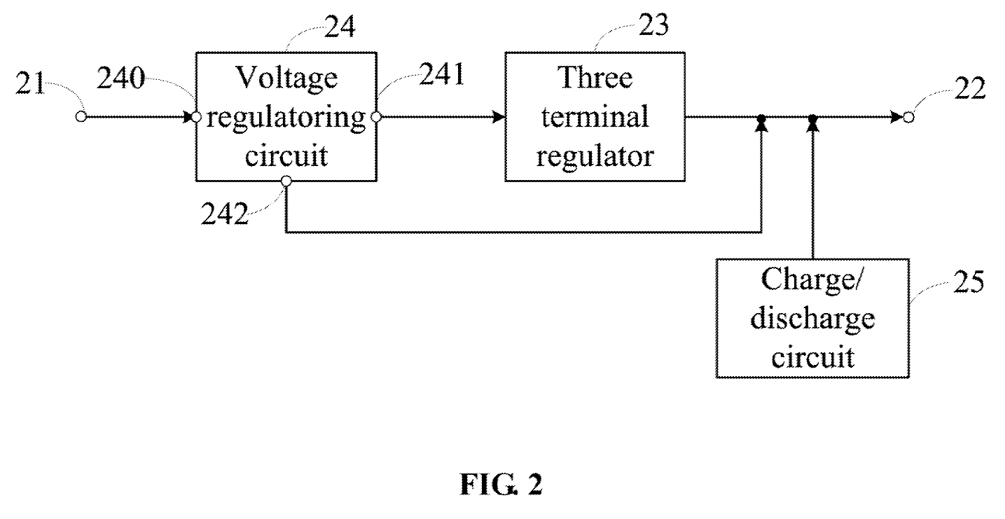

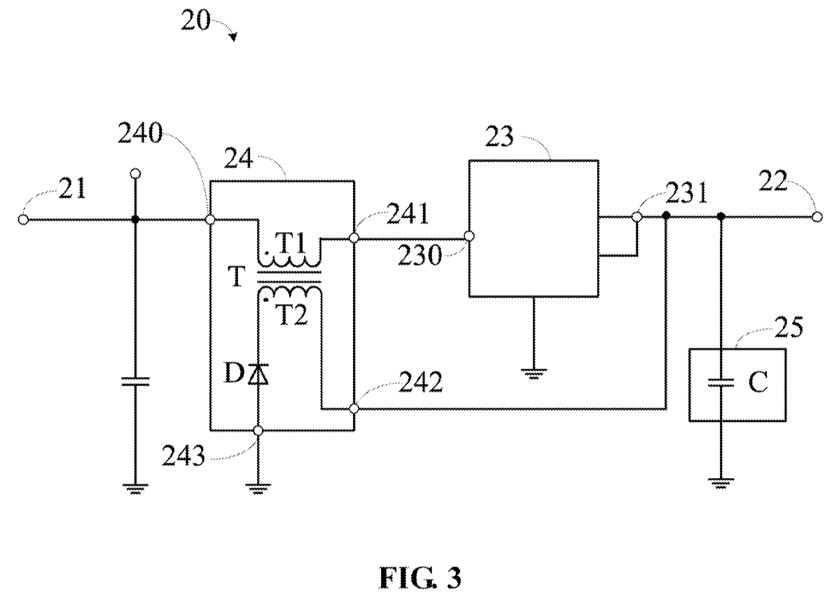

Referring to FIGS. 2-3, a power circuit 20 employed in a power supply device powers an electronic device connected to the power circuit 20. The power circuit 20 includes a power input port 21, a power output port 22, a three-terminal regulator 23, a voltage regulating circuit 24, and a charge/discharge circuit 25. The three-terminal regulator 23 includes an input port 230, a first output port 231, and a second output port 232. The first output port 231 is connected to the second output port 232 to form a regulator output port 233 of the three-terminal regulator 23. The voltage regulating circuit 24 includes a first terminal 240, a second terminal 241, a third terminal 242, and a fourth terminal 243. The first terminal 240 is connected to the power input port 21. The second terminal 241 is connected to the input port 230 of the three-terminal regulator 23. The third terminal 242 is connected to the power output port 22. The fourth terminal 243 is grounded. The charge/discharge circuit 25 and the regulator output port 233 of the three-terminal regulator 23 are both connected to the power output port 22.

In the embodiment, the three-terminal regulator 23 is capable of detecting a voltage value at the regulator output port 233 and enabling or disabling the input port 230 depending on the detected voltage value. If the three-terminal regulator 23 determines the detected voltage value is less than a predetermined voltage value, the three-terminal regulator 23 enables the input port 230 to receive voltage signals output by the voltage regulating circuit 24. If the three-terminal regulator 23 determines the detected voltage value is equal to or greater than the predetermined value, the three-terminal regulator 23 disables the input port 230. In the embodiment, the predetermined voltage value is 3.3V.

In the embodiment, the voltage regulating circuit 24 includes a transformer T and a diode D. The transformer T includes a primary coil T1 and a secondary coil T2. The primary coil T1 is connected between the power input port 21 and the input port 230 of the three-terminal regulator 23. A first terminal of the secondary coil T2 is connected to the power output port 22, a second terminal of the secondary coil T2 is grounded via the diode D which is connected in reverse. The charge/discharge circuit 25 includes a capacitor C. A first terminal of the capacitor C is connected to the power output port 22 and a second terminal is grounded.

When a power supply (not shown) is connected to the power input port 21 for powering an electronic device (not shown) connected to the power output port 22, the voltage value of the power input port 21 is equal to the voltage value of the power supply, and the voltage value of the power output port 22 is zero. Thereby, the voltage value of the regulator output port 233 of the three-terminal regulator 23 is equal to that of the power output port 22, namely zero, and the three-terminal regulator 23 determines that the voltage value of the regulator output port 233 is lower than the predetermined value and so enables the input port 230. The electric current provided by the power supply flows into the voltage regulating circuit 24 to drive the primary coil T1 to generate induction. The secondary coil T2 generates voltage according to the generated induction. Then the current flowing through the primary coil T1 is also provided to the three-terminal regulator 23 to charge the capacitor C of the charge/discharge circuit 25. Therefore, a portion of the power provided by the power supply is conducted to secondary coil T2, and another portion of the power provided by the power supply is conducted to the three-terminal regulator C to charge the charge/discharge circuit 25.

The voltage value of the power output port 22 increases following the increase of the voltage across the capacitor C of the charge/discharge circuit 25. When the voltage value of power output port 22 is equal to or greater than the predetermined voltage value, the three-terminal regulator 23 disables the input port 230, thereby the current provided by the power supply flows only to the primary coil T1 and the secondary coil T2 generates a voltage accordingly. Then the voltage generated by the secondary coil T2 and the voltage provided by the capacitor C are used for powering the electronic device connected to the power output port 22.

The power supply transition efficiency is computed by a formula: P′=(Vout1+Vout2)Vin=(Vout1++Vout2)/U, wherein Vout1 is the voltage value of the secondary coil T2, Vout2 is the voltage value of the capacitor C of the charge/discharge circuit 25, namely 3.3V, and U is the voltage value of the power supply 20. If the voltage value provided by the power supply is 12V, the power supply transition efficiency can be easily determined.

The power converted to heat and thus lost is computed by a formula: Pd′=(Vin*P′−Vout2)*I=(U*P′−Vout2)*I, wherein, the I is the current output by the secondary coil T2 and the capacitor C of the voltage regulating circuit 24. If the current output by the secondary coil T2 and the capacitor C of the voltage regulating circuit 24 is 0.5 A, the heat consumption efficiency can be easily determined.

Therefore, the power supply transition efficiency P′ of the power circuit 20 of the present embodiment is greater than the power supply transition efficiency P of the power circuit 20 of related art, and the consumption or loss Pd′ of the power circuit 20 of the present embodiment is less than the consumption Pd of the power circuit 10 of the related art.

The voltage value of the capacitor C of the voltage regulating circuit 25 reduces when power to the electronic device is continued, and the voltage value of the power output port 22 is reduced accordingly. When the voltage value of the power output port 22 is less than the predetermined voltage, the three-terminal regulator 23 enables the input port 230. The current provided by the power supply once again charges the capacitor C of the charge/discharge circuit 25.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A power circuit comprising:
a power input port configured for being connected to a power supply;
a power output port configured for being connected to an electronic device;
a three-terminal regulator comprising an input port, a first output port, and a second output port, the first output port connected to the second output port to form a regulator output port of the three-terminal regulator, the regulator output port being connected to the power output port, wherein the three-terminal regulator is configured for detecting a voltage value of the regulator output port, and enabling the input port if the detected voltage value is less than a predetermined voltage value and disabling the input port if the detected voltage value is not less than the predetermined value;
a voltage regulating circuit comprising a first terminal connected to the power input port, a second terminal connected to the input port of the three-terminal regulator, and a third terminal connected to the power output port; and
a charge/discharge circuit connected to the power output port, and configured for being charged by a power supply connected to the power input port if the input port of the three-terminal regulator is enabled, and further powering an electronic device connected to the power output port if the input port of the three-terminal regulator is disabled.

2. The power circuit as claimed in claim 1, wherein the voltage regulating circuit comprising a transformer and a diode, the transformer comprising a primary coil connected between the power input port and the input port of the three-terminal regulator and a secondary coil with a first terminal being connected to the power output port and a second terminal being grounded via the diode which is connected reversely.

3. The power circuit as claimed in claim 2, wherein if the input port of the three-terminal regulator is enabled, a portion of current provided by the power supply flowing to the voltage regulating circuit drives the primary coil to generate induction and the secondary coil to generate a voltage according to the generated induction, the remaining portion of the current provided by the power supply flowing to the voltage regulating circuit flowing through the three-terminal regulator to charge the charge/discharge circuit;
if the input port of the three-terminal regulator is disabled, the current provided by the power supply totally flows to the voltage regulating circuit to drive the primary coil to generate induction and the secondary coil to generate a voltage according to the generated induction.

4. The power circuit as claimed in claim 1, wherein the charge/discharge circuit comprises a capacitor with a first terminal being connected to the power output port and a second terminal being grounded.

5. The power circuit as claimed in claim 1, wherein the predetermined voltage value is a constant voltage value output by the three-terminal regulator.
